(19) United States
(12) Patent Application Publication
(10) Pub. No.: US 2003/0014406 A1
(43) Pub. Date: Jan. 16, 2003

(54) Intelligent browser windows in a multi-browser environment

(75) Inventors: Baldo Faieta, San Francisco, CA (US); Lalit Balchandani, San Francisco, CA (US); Derek Chung, San Francisco, CA (US); Ishantha Lokuge, Pacheco, CA (US); Yin Yin Wong, San Francisco, CA (US)

Correspondence Address: Lalit Balchandani, 3288 21st St. #151, San Francisco, CA, 94110, US

(73) Assignee: URBANPIXEL INC., SAN FRANCISCO, CA (US)

(21) Appl. No.: 10/165,389

(22) Filed: Jun. 7, 2002

Related U.S. Application Data
(60) Provisional application No. 60/297,206, filed on Jun. 7, 2001.

(51) Int. Cl. G06F 7/00

(52) U.S. Cl. 707/5

(57) ABSTRACT

The system described herein extends the server described in application Ser. No. 09/596,305 to allow the content of browser windows or the interaction of browser windows to affect other browser windows or to be affected by other browser windows. This system of linked browser windows allows intelligence to be added to the system specified in application Ser. No. 09/596,305. Changes affecting a browser window can now have ripple effects through the landscape for various uses, e.g., data can propagate more visibly, easily and transparently, “what-if” scenarios are possible, error and special conditions can be highlighted at a glance, etc.

### RELATED APPLICATION DATA

The present application is related to U.S. patent application Ser. No. 09/596,305 (Attorney Docket No. URBAP001), naming Wong et al. as inventors, and filed Jun. 14, 2000. That application is incorporated herein by reference in its entirety for all purposes.

The present application claims priority under 35 U.S.C. § 119 to U.S. Provisional Application Serial No. 60/297,206 (Attorney Docket No. URBAP004P), naming Faieta et al. as inventors, and filed Jun. 7, 2001. A copy of the U.S. Provisional Application Serial No. 60/297,206 is attached hereto as Appendix A, and is incorporated herein by reference in its entirety for all purposes.

### BACKGROUND OF THE INVENTION

The present invention relates generally to computer networks and more particularly to techniques for facilitating the process to manage and build web-based data-centric applications in a data network.

The proliferation of the Internet in all aspects of business operations has been fueled by the need for people to have instant access for data relating to their work. Businesses generate an incomparable amount of data in relation to their everyday operations. This data has to be digested by managers at all levels in the organization in order to do informed decisions for their planning, budgeting, strategy, forecasting, etc.

Businesses have created so called “information portals” by which every employee can not only have access in real time to information through a browser about the business but also collaborate by continuously updating it through a web interface so that other managers can act upon the changed data.

The Internet development community has established various standards for data interchange (e.g., SOAP, XML) and protocols (e.g., web services protocols UDDI, WSDL) to help businesses build these information portals so that data coming from different systems across the data network is accessible and updateable through a web browser.

In order to support these web-based information portals, IT departments struggle to keep up as they have to figure out who needs to see what kind of information and how to better percolate and aggregate changes in the data to the business people who need to see it.

Given that the information portals are setup as conventional web sites, where data and information is organized in a hierarchical fashion, managers have a hard time getting a good idea of the net effect of their actions because they have to visit page upon page of information and data in order to get it. In this same way, the evaluation of different options through the use of what-if scenarios is complicated by the way the information portals are organized and built. Moreover, sharing and collaborating over this ever changing data is difficult to do.

The organization of businesses also have become more fluid as they have to adapt to this fast-pacing environment and managers at all levels have to rely on information that percolates up within their divisions, but also on information and collaboration with people coming from people across other divisions. The adhoc nature of this process of information flow and collaboration complicates the job for IT departments as is hard to codify this ever-changing networks of information dependencies within organizations.

Against this backdrop, it will be appreciated that there exists an ongoing desire to improve the process by which data-centric applications over the web are built, viewed, analyzed, shared and maintained and that address the problems described above.

### SUMMARY OF THE INVENTION

According to specific embodiments, the techniques of the present invention provide a mechanism for enabling a new type of interactive data-centric web site where users can create and use web spaces that behave much like spreadsheets of browsers. Browsers with data fed by web servers become the cells of these browser spreadsheets. The technology of the present invention allows for the browsers to have formulaic dependencies much like cells in spreadsheets, and in the same venue, when data changes in one of the browsers, dependent browsers would update accordingly. Moreover the visual and interactive techniques of the present invention as described herein enable users to work together within the same browser spreadsheet collaborating and interacting in real time.

As described in greater detail below, the techniques of the present invention provides a number of advantages over conventional techniques for creating and using data-centric web sites. For example, by placing browsers with related data side by side as part of a browser spreadsheet, users can at a glance see the effects on changes to the data. Moreover, by using interactive techniques described in more detail herein, users can apply operations to whole sets of data in browsers, and therefore be more efficient in the analysis of data through the web.

In this same way, the present invention facilitates what-if scenarios because dependencies between data across browsers can be easily modified and therefore improve the time by which alternative options are being tried out. Because of the ease by which the dependencies can be setup and maintained between browsers with served data, users can create and maintain themselves the complex information flow networks and therefore be more flexible in the way an organization shares, percolates and aggregates information.

In one aspect, the invention provides a computer network user interface. The interface includes a computer network browsing environment having a graphical spatial context, sometimes organized as a grid, to associate web pages with data to one another and associate control structures to these web pages.

In another aspect, the invention provides a computer network system. The system includes one or more network servers each having a processor and a memory, and one or more network clients connected with the network servers each having a processor, a memory, a display, and a network connector. The system also includes a network user interface having a computer network browsing environment which provides a graphical spatial context, sometimes organized as a grid, to associate web pages with data to one another and associate control structures to these web pages.

In still another aspect, the invention provides a method, implemented on a computer system, for providing a computer network browsing environment. The method involves integrating information from browsing the computer network into a single graphical spatial environment. Also provided is a computer program product for effecting a method in accordance with the present invention.

These and other features and advantages of the present invention will be presented in more detail in the following specification of the invention and the accompanying figures that illustrate by way of example the principles of the invention.

### BRIEF DESCRIPTION OF THE DRAWINGS

FIG. 1 shows an example of a graphical user interface 100 that has been implemented in accordance with a specific embodiment of the present invention

FIG. 2 shows an illustrative example of XML data 200 that would be stored as content for a plot associated to spreadsheet browser window in accordance with a specific embodiment of the present invention.

FIG. 3 shows another illustrative example of XML data 300 that would be stored as content for a plot associated to spreadsheet browser window in accordance with a specific embodiment of the present invention.

FIG. 4 shows a diagram 400 for the extension to the system in U.S. patent application Ser. No. 09/596,305 in which it specifies a control sheet 403 in addition to the already defined sheets in U.S. patent application Ser. No. 09/596,305.

FIG. 5 illustrates a flowchart 500 suitable for implementing the extensions to U.S. patent application Ser. No. 09/596,305 in accordance with one embodiment of the present invention.

FIG. 6 shows a network device 60 suitable for implementing the electronic commerce techniques of the present invention.

### DETAILED DESCRIPTION OF THE PREFERRED EMBODIMENTS

Reference will now be made in detail to some specific embodiments of the invention. Examples of these specific embodiments are illustrated in the accompanying drawings. While the invention will be described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

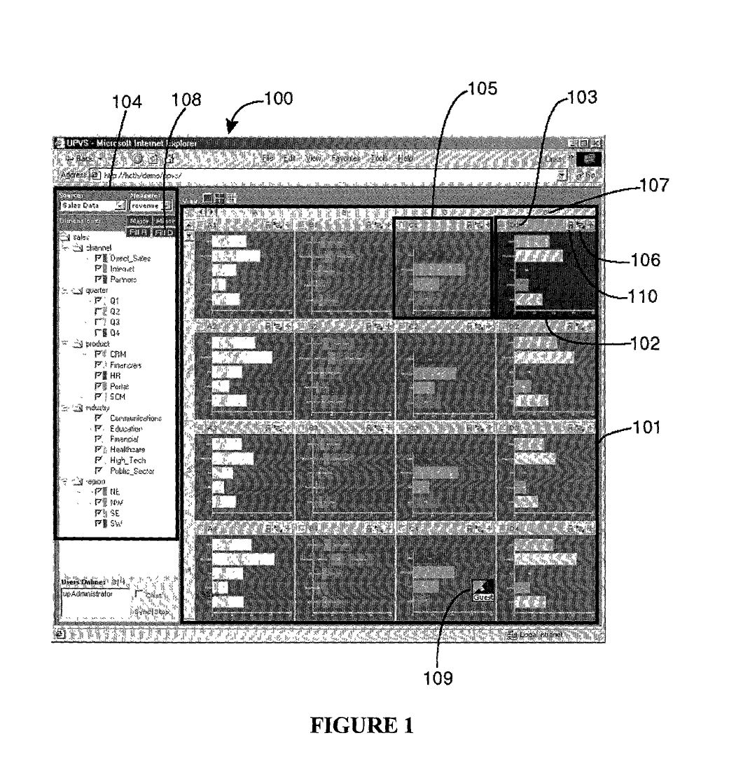

FIG. 1 shows an example of a graphical user interface 100 through an Internet browser that has been implemented in accordance with a specific embodiment of the present invention. For the purposes of this application, web pages holding data are referred to as “spreadsheet browser windows” and the sheet as the “browser spreadsheet.” As shown in FIG. 1, the browser spreadsheet 101, which according to a specific embodiment corresponds to a two-dimensional virtual sheet that host multiple tiled spreadsheet browser windows like 102.

It should be noted that in other embodiments of the present invention, the placement of the spreadsheet browser windows need not be organized as a grid or have to be abutted against each other and they may be separated from each other in the sheet by negative space. Spreadsheet 101 as shown in the graphical user interface shows only 4 rows, 1 to 4, by 4 columns, A to D, of spreadsheet browser windows. According to different embodiments, it may vary in size and have many more rows and columns, in which case only a portion of the browser spreadsheet would be shown through the graphical user interface 100 and the user would have to scroll to view different parts of the browser spreadsheet. According to one embodiment of the present invention, browser spreadsheets would be implemented using mechanisms to host browser windows with landscape sheets as described in U.S. patent application Ser. No. 09/596,305.

For the purposes of this example, spreadsheet browser window 102 corresponds to cell D1 in the browser spreadsheet 101 and holds sales data for products filtered to include only the data for quarter Q1. In the specific embodiment of the present invention, the sales data, which may be served using various Internet standards for data interchange such as XML or SOAP, may be transformed into formats that an Internet browser can show such as HTML or Flash, using various styles that may be specified by a Stylesheet, again using various internet standards like XSL, and for the purposes of this application is shown as a graph, but in other embodiments may be shown as a table or any appropriate information format suitable for the application. According to one embodiment of the present invention, data in spreadsheet browser windows would be implemented using mechanisms to store content in plots as described in U.S. patent application Ser. No. 09/596,305.

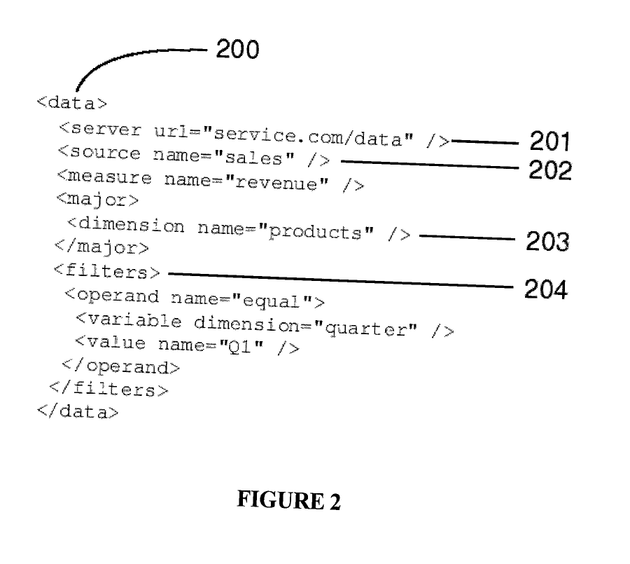

According to a specific embodiment of the present invention, FIG. 2 shows an illustrative example of XML data 200 that would be stored as content for the plot associated to spreadsheet browser window 102 and would describe to a server the data that should be served to display the sales data that is shown in spreadsheet browser window 102. It should be noted that the XML data 200 is just a specification for server 201 to serve data from source 202 for dimension 203 applying filters 204 and not the actual data that is being served.

According to the specific embodiment of the present invention, clicking on the spreadsheet browser window label 103, would select it at which point, for this specific embodiment, the user may change or modify the data served to spreadsheet browser window 102 and use the application controls 104 to specify the data that should be shown in 102. The application controls 104 would modify XML data 200 which in turn would specify to the server 201 to serve a new data to the spreadsheet browser window 102. It should be noted that in other embodiments of the present invention, there are multiple options to specify which data should be served to a spreadsheet browser window and these ones are derived from mechanisms described in U.S. patent application Ser. No. 09/596,305.

One embodiment of the present invention assigns “control elements” to spreadsheet browser windows. Control elements are procedural subroutines specified using various Internet standards for specifying procedures such as JavaScript, Java, etc. or even rule-based languages to transform XML like XSL. These control elements are stored together with the content of spreadsheet browser windows in a database system. As described in more detail below, procedures of control elements may use data from other spreadsheet browser windows to generate the data for their spreadsheet browser windows.

So, for example, the XML data 200 that specifies to server 201 to serve data to spreadsheet browser window 102 could be based on a formula, that refers to the data stored as content for spreadsheet browser window 105, which corresponds to cell C1, and holds sales data for regions filtered to include only the data for quarter Q1.

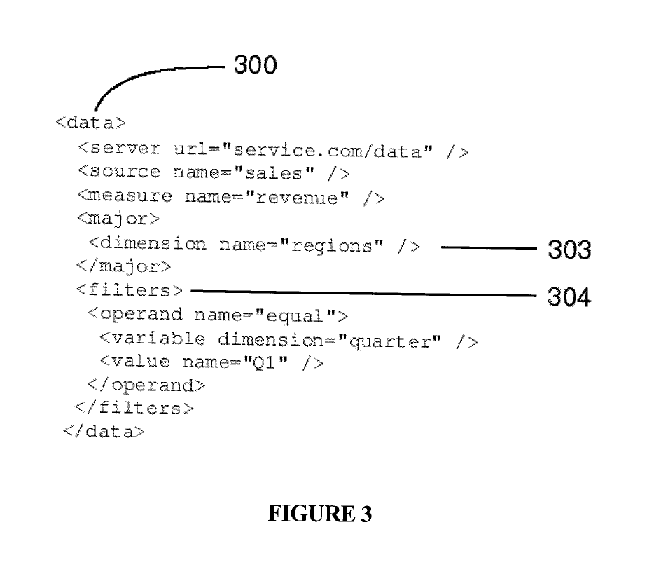

FIG. 3 shows an illustrative example of XML data 300 that would be stored as content for the plot associated to spreadsheet browser window 105 and would describe to a server the data that should be served to display the sales data that is shown in spreadsheet browser window 105. It should be noted that the XML data 300 serves data for dimension 303 (regions) and applies filters 304 (include only the data for quarter Q1).

The formula in the control element for spreadsheet browser window 102 could say to use the XML data 300 but change the dimension 303 from regions to products. This formula would generate XML data identical in nature to that one specified for XML data 200 and therefore the server 201 would serve the same data to spreadsheet browser window 102. In one embodiment of the present invention, references to other spreadsheet browser windows in the formulas could use either absolute references like the unique Ids of the referred spreadsheet browser windows or, if the spreadsheet is organized as a grid, more relative references using row or column offsets from the current location in the grid of the spreadsheet browser windows.

According to a specific embodiment of the present invention, the formula in the control element could be specified using JavaScript, which would be extended with the appropriate Application Program Interface (API) to access and refer to data from other spreadsheet browser windows. For this specific embodiment, accessing and modifying XML markup language can be accomplished using Internet standards extensions to JavaScript such as DOM (Document Object Model). For this specific embodiment, clicking on the “link” icon 106 would bring a dialog box where the user can type the formula. Alternatively, the application controls 104 could create automatically the formula assigned to the selected spreadsheet browser window.

Once the formula in the control element for spreadsheet browser window 102 would be setup, any time the user would change the data from spreadsheet browser window 105, using techniques described above for the specific embodiment of the graphical interface 100, the data for spreadsheet browser window 102 would change accordingly. So, for example, if the user would add a new filter to the XML data 300, to include also data from quarter Q2, this change would be reflected immediately in the data for spreadsheet browser window 102 showing the sales data that include also data from quarter Q2.

According to the specific embodiment of the present invention, clicking on the spreadsheet column label 107, would select the whole column D at which point, for this specific embodiment, the user may change or modify the data served to spreadsheet browser windows in column D using the application controls 104 to specify the data. If the spreadsheet browser window 102 has been assigned a control element with the formula from the example above, then the user could use a “fill Down” spreadsheet function by pressing on the button 108 of the application controls 104 at which point the control element would be duplicated for all spreadsheet browser windows of column D. If relative references are used in the formula, for example, the formula for control element of spreadsheet browser window 102 would use a column offset of −1 to refer to spreadsheet browser window 105, these relative references would have the desired effect in that the formula of the control element for spreadsheet browser window D2 would refer to spreadsheet browser window C2 and the formula of the control element for spreadsheet browser window D3 would refer to spreadsheet browser window C3 and so on.

Also displayed within the spreadsheet 101 of FIG. 1 is a proxy symbol 109, which represents the user's current location within the spreadsheet. A mechanism for generating and maintaining proxy information relating to one or more users is described in U.S. patent application Ser. No. 09/596,305. As more users would be viewing the spreadsheet, their corresponding proxy symbols would be shown in the spreadsheet. According to the specific embodiment of the present invention, a mechanism for updating browser windows across Internet browsers from different users is described in U.S. patent application Ser. No. 09/596,305. Through this mechanism, changes in the data from any spreadsheet browser window would be propagated to all the Internet browsers viewing the spreadsheet. However, for the specific embodiment of the present invention, these changes would only be propagated once the user presses the “check-in” button 110. This feature has the advantage that users can try what-if scenarios without changing the actual spreadsheet and only update it once they are comfortable with the changes. In another embodiment of the present invention, changes across Internet browsers could be propagated all the time without the “check-in” feature.

### SYSTEM COMPONENTS AND CHARACTERISTICS

The characteristics of the components of the system, and the processes by which they operate in preferred embodiments of the invention are described below. As described in further detail below, the system exists in a network environment in which client software runs on an individual user's computer. The client communicates with server software over the computer network.

According to one embodiment of the present invention, the system described in U.S. patent application Ser. No. 09/596,305 allows for a landscape sheet of tiled browser windows that are presented to an Internet user via a client and a server. The server delivers HTML content and geometric structure to the client per requests based on area. The client uses an HTML rendering engine (e.g., Microsoft Internet Explorer, Netscape Navigator, etc.) to display data. The data is shown in browser windows whose geometric structure is also delivered by the server.

Since tiled browser windows are used, the users of such systems have the ability to interact independently with each window. Interactions include: form filling and posting, following links, etc. Basically any interaction allowed by the underlying HTML rendering engine is possible. These interactions might be handled by the servers specified in U.S. patent application Ser. No. 09/596,305 or by any server referred to by the content of the browser window.

In one embodiment of the present invention, the server described in U.S. patent application Ser. No. 09/596,305 is extended to allow the content of browser windows or the interaction of browser windows to affect other browser windows or to be affected by other browser windows. This system of linked browser windows allows intelligence to be added to the system specified in application Ser. No. 09/596,305. Changes affecting a browser window can now have ripple effects through the landscape for various uses, e.g., data can propagate more visibly, easily and transparently, “what-if” scenarios are possible, error and special conditions can be highlighted at a glance, etc.

Control Sheet

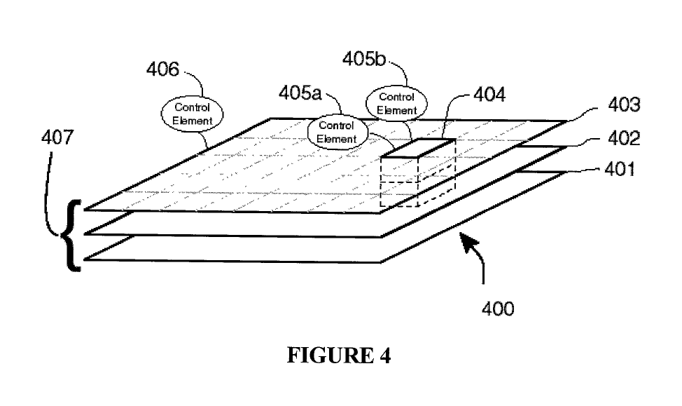

According to one embodiment of the present invention, FIG. 4 shows a diagram 400 for the extension to the system in U.S. patent application Ser. No. 09/596,305 in which it specifies a control sheet 403 in addition to the proxy sheet 402 and the landscape sheet 401 as described in U.S. patent application Ser. No. 09/596,305. This control sheet 403 operates upon it and the other sheets. This new sheet is built of control elements. The combination of the control sheet 403, the proxy sheet 402, and the landscape sheet 401 we call it browser spreadsheet 407 as shown in diagram 400. In the previous section, we presented a specific embodiment of the browser spreadsheet.

Control Elements

Control elements are attached to browser windows or to the landscape sheet. In diagram 400, we see that the browser window 404 has 2 control elements 405a and 405b attached to it. The landscape sheet 401 has one control element 406 attached to it. The combination of a browser window together with their associated control elements we call it spreadsheet browser window. In the previous section, we presented specific embodiments of the spreadsheet browser windows. As described before, control elements are procedural subroutines specified using various Internet standards for specifying procedures such as JavaScript, Java, etc. or even rule-based languages to transform XML like XSL. These control elements are stored together with the content of spreadsheet browser windows in a database system. When defined, the control elements would make use of APIs that give access to the current browser window data and can access other browser window data in the landscape sheet.

A browser window may have any number of control elements attached to it. Similarly, the landscape sheet may have zero, one or many control elements attached. Control elements can be triggered by various events: Timers, other control elements, user actions or the loading/refreshing of the content in the browser window. Multiple control elements associated with a single browser window are triggered in an order specified in the control layer and dependent on the sequence by which the control elements where defined.

In one embodiment of invention described in U.S. patent application Ser. No. 09/596,305 it is specified that the content for each browser window can take many forms in the server: HTML, XML+XSL, RSS, etc. According to one embodiment of the present invention, the system allows the content or data of each browser window to be identified using standard Internet models for accessing the nodes in a markup language (e.g., DOM for HTML, SOAP for XML, etc.) and in this way make available to control elements this markup data.

According to one embodiment of the present invention, control elements extract whole or parts of data from a browser window, which is interpreted as markup data (i.e., XML-based), to perform actions that ultimately affect the final markup that is being rendered in the browser window. Before rendering the markup data, Stylesheets (e.g., XSL) can be applied to it and sent to the browser.

According to one embodiment of the present invention, control elements can select marked up data (e.g., XML, HTML, SOAP) of their associated browser window as well as data of other browser windows through out the landscape, or of data at the landscape level. However, they can only directly change the data of their associated object (browser window of landscape) or they can change themselves.

Control elements of a particular browser window may use the data of other browser windows by reference of the browser window Ids (unique identification of the browser window for its landscape sheet) or, if the browser windows are organized in the landscape sheet as a grid, by absolute row and columns references (e.g., row[i], col[j]) or relative row and column references to the particular browser window (e.g., current_row[−1], current_col[+2]).

Control elements can trigger notifications for changes/updates to other control elements at the same browser window or at other browser windows or at the landscape level. The server described in application Ser. No. 09/596,305 can then send/forward these changes/updates to various clients that are viewing the affected browser windows which in turn would refresh their views.

One of the uses of the control elements associated with a landscape sheet could be to summarize the data in the whole sheet so that it can be included into a browser window of a separate landscape sheet. This feature can be particularly useful to create hierarchies of sheets where changes in browser windows for sheets in branches can percolate to sheets closer to the root.

### SYSTEM IMPLEMENTATION

Along with such data servers, the extension to the system in U.S. patent application Ser. No. 09/596,305 could be implemented as follows. The control sheet and its component elements would be stored in the normal data store as in the system described in U.S. patent application Ser. No. 09/596,305. A control sheet manager component would manage the control elements for a landscape sheet.

The system in U.S. patent application Ser. No. 09/596,305 sends the data (e.g., HTML, XML+XSL) associated with the browser windows that overlap the regions been viewed by a particular client. The implementation for the extensions proposed herein to the system in U.S. patent application Ser. No. 09/596,305 adds additional steps before the actual browser window is rendered within the client.

Process: Loading Data to Browser Windows

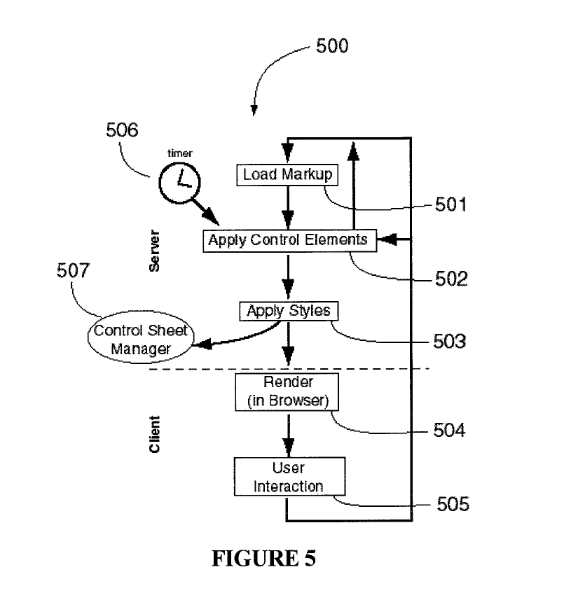

FIG. 5 illustrates a flowchart 500 suitable for implementing the extensions to U.S. patent application Ser. No. 09/596,305 in accordance with one embodiment of the present invention. 501 instantiates at the server the data (markup XML-based) associated with a particular browser window. 502 runs the control elements associated with a browser window in the sequence they were defined. 502 also instantiates for every control element, additional markup data associated with browser windows used by the control element and then runs the control element. 506 runs other control elements associated with the browser window that match triggers set by timers, other control elements or user input (at the browser). 503 optionally applies a style to the markup resulting from the application of the control elements associated with the browser window. The resulting markup is sent to the various clients that are browsing the particular browser window and in turn the clients would render at 504 in the corresponding browsers. 502/503 notifies the control sheet manager 507 that this browser window has changed provided that the markup is different than the one already sent for the particular browser window (stopping condition). User interaction at 505 may result in loading/reloading additional markup data, which may be opportunities to trigger additional control elements in the server.

Control Sheet Manager

The control layer manager keeps track what browser windows need to be changed and which control elements should be triggered based on triggers set by various control elements or time-based, inputs such as client notifications, etc. It also handles changes to the control layer and pass other changes to the other layers: proxy or landscape layer. The control layer manager keeps a dependency graph for every browser window, and its associated control elements. Whenever a browser window changes, it notifies its dependent browser windows (and their control elements) that they should be updated/recalculated as specified in the process above (Loading data to browser windows). Provisions for cyclic loops of execution in the dependency graph have to be made in the implementation. Also, optimizations to find lists of control elements that affect each other could be performed and the results stored in the normal data store.

### OTHER EMBODIMENTS

Generally, the electronic commerce techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the electronic commerce technique of this invention may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. Specific examples of such network devices include routers and switches. For example, various aspects of the present invention may be implemented on specially configured routers or servers. A general architecture for some of these machines will appear from the description given below. In an alternative embodiment, the electronic commerce technique of this invention may be implemented on a general-purpose network host machine such as a personal computer or workstation. Further, the invention may be at least partially implemented on a card (e.g., an interface card) for a network device or a general-purpose computing device.

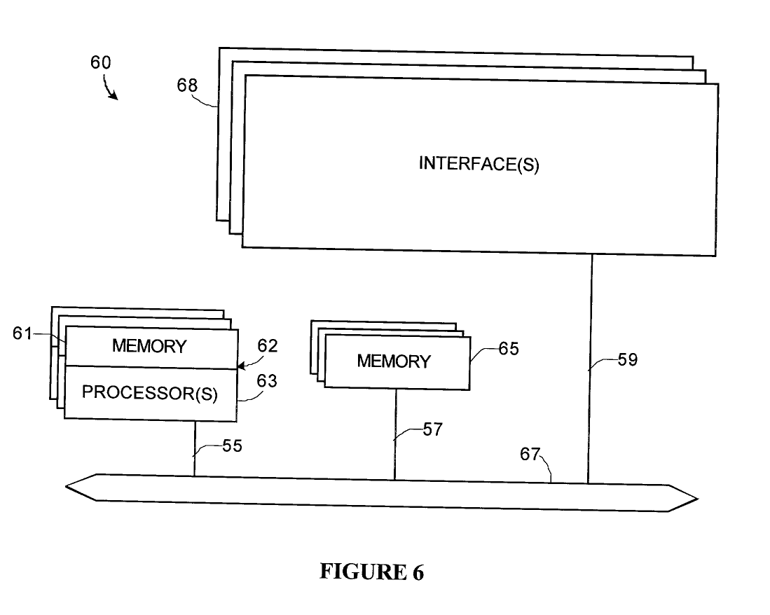

Referring now to FIG. 6, a network device 60 suitable for implementing the electronic commerce techniques of the present invention includes a master central processing unit (CPU) 62, interfaces 68, and a bus 67 (e.g., a PCI bus). When acting under the control of appropriate software or firmware, the CPU 62 may be responsible for implementing specific functions associated with the functions of a desired network device. For example, when configured as a server device, the CPU 62 may be responsible for analyzing packets, encapsulating packets, forwarding packets to appropriate network devices, responding to HTTP requests, etc. The CPU 62 preferably accomplishes all these functions under the control of software including an operating system (e.g. Windows NT), and any appropriate applications software.

CPU 62 may include one or more processors 63 such as a processor from the Motorola family of microprocessors or the MIPS family of microprocessors. In an alternative embodiment, processor 63 is specially designed hardware for controlling the operations of network device 60. In a specific embodiment, a memory 61 (such as non-volatile RAM and/or ROM) also forms part of CPU 62. However, there are many different ways in which memory could be coupled to the system. Memory block 61 may be used for a variety of purposes such as, for example, caching and/or storing data, programming instructions, etc.

The interfaces 68 are typically provided as interface cards (sometimes referred to as “line cards”). Generally, they control the sending and receiving of data packets over the network and sometimes support other peripherals used with the network device 60. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 62 to efficiently perform routing computations, network diagnostics, security functions, etc.

Although the system shown in FIG. 6 illustrates one specific network device of the present invention, it is by no means the only network device architecture on which the present invention can be implemented. For example, an architecture having a single processor that handles communications as well as routing computations, etc is often used. Further, other types of interfaces and media could also be used with the network device.

Regardless of network device's configuration, it may employ one or more memories or memory modules (such as, for example, memory block 65) configured to store data, program instructions for the general-purpose network operations and/or other information relating to the functionality of the electronic commerce techniques described herein. The program instructions may control the operation of an operating system and/or one or more applications, for example. The memory or memories may also be configured to

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

According to specific embodiments, the techniques of the present invention may be implemented using well-known, conventional platforms such as, for example, XML, Java, JavaScript and DHTML. Further, according to a specific embodiment, the various aspects of the present invention may be implemented in conventional systems without requiring the use of plug-ins. Further, according to different embodiments, the technology of the present invention may either be adopted as a service via an Application Service Provider (ASP) or via a software license. In a specific embodiment, the technique of the present invention may be implemented on a server system that is accessible by Internet end-users. The technique in the present invention may be configured to be compatible with conventional Internet browser applications such as, for example, Internet Explorer and Netscape Navigator. Thus, according to at least one embodiment, conventional Internet browser applications may be used to implement various aspects of the present invention without requiring use of additional software or plug-ins.

In at least one embodiment, specific user information may be stored locally within a cookie or file on the user's computer. Such information may include, for example, user specific registration information (e.g. username, user ID, password, etc.), and information relating to the user's proxy location during the current and/or previous browsing session with a particular web site.

### CONCLUSION

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A method for effecting interactive, data-centric, information aggregation, delivery, analysis and modification via a data network, the data network including a server system configured to host a web site associated with a first content provider, the data network further including a client system configured or designed to implement a browser application, the browser application being configured or designed to facilitate access to the web site by a first user, the method comprising:
a graphical spatial environment for simultaneous display of structured and unstructured data from multiple sources in various formats;
wherein, the dependencies between data are easily setup and maintained to allow efficient creation and operation of complex information flow networks, ease of operation with large sets of data
wherein data changes propagate through the graphical spatial environment via the aforementioned dependencies.

2. The method of claim 1 further comprising a multiple browser format with formulaic dependencies much like cells in spreadsheets.

3. The method of claim 1 further provides for interaction between a plurality of users changing data within the spreadsheet of browsers. Data changes propagate based on aforementioned dependencies and refreshes each users' view.
